(19) United States
(12) Patent Application Publication
(10) Pub. No.: US 2021/0179828 A1
(43) Pub. Date: Jun. 17, 2021

(54) Polymer Composition Comprising Polypropylene

(71) Applicant: TOTAL RESEARCH & TECHNOLOGY FELUY, Seneffe (BE)

(72) Inventors: Alain Standaert, Bruxelles (BE); Daniel Libert, Court-Saint-Etienne (BE); Katty Den Dauw, Woluwè-Saint-Lambert (BE)

(21) Appl. No.: 16/760,364

(22) PCT Filed: Oct. 27, 2018
(86) PCT No.: PCT/EP2018/079521

§ 371 Date: Apr. 29, 2020

(30) Foreign Application Priority Data
Oct. 31, 2017 (EP) 17199440.3

(51) Int. Cl. C08L 23/12

(52) U.S. Cl. CPC C08L 23/12; C08L 2205/035; C08L 2205/025

(57) ABSTRACT

The present invention relates to a polymer composition comprising:
at least 31.0% by weight of a polypropylene (PP1) based on the total weight of the polymer composition;
a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
a second polyethylene (B) having a melt flow rate MI2 inferior to 2.0 g/10 min as determined according to ISO 1133, condition D, at 190° C. and under a load of 2.16 kg; and
optionally an ethylene vinyl acetate copolymer.

The present invention also relates to an article comprising a polymer composition according to the invention and further relates to a process for making said article.

### FIELD OF THE INVENTION

The present invention relates to a polymer composition comprising polypropylene, to the use of said polymer composition for the preparation of an article and to said article comprising said polymer composition.

### BACKGROUND OF THE INVENTION

Polypropylene products are used in many applications where mechanical properties are of high importance (crates, bins, boxes, trays, automotive parts, food packaging produced by injection molding, extrusion blow molding, extrusion thermoforming, etc.); relevant mechanical properties include stiffness and impact resistance. Processing and aesthetical properties are also of high importance for most converters and end-users.

The traditional method of modifying the impact resistance of polypropylene is by addition of a dispersed polymeric phase offering impact resistance; this can be achieved by extrusion blending or by copolymerization. Impact modifier polymers include elastomers, plastomers, EPR, EPDM, PBu, SEBS, LDPE, LLDPE, HDPE, . . . . The limitation of this technique is often linked to the rapid loss of stiffness and the lack of compatibility between the dispersed phase and the polypropylene matrix. Amorphous elastomers increase the impact resistance with a high efficiency but have a detrimental effect on the stiffness while semi-crystalline polymers such as polyethylene have a less detrimental effect on the stiffness but a limited effect on the impact resistance; moreover the compatibility between polypropylene and polyethylene is often an issue if the quantity or the viscosity of the polyethylene phase is too high.

There is therefore a demand for polymer compositions comprising polypropylene having improved mechanical properties such as stiffness, impact resistance and good processability.

It is therefore an object of the present invention to provide polymer composition comprising polypropylene having improved mechanical properties.

### SUMMARY OF THE INVENTION

It has now surprisingly been found that the above objective can be attained either individually or in any combination by a polymer composition comprising the specific and well-defined polymers as disclosed herein.

In a first aspect, the present invention provides a polymer composition comprising:
at least 31.0% by weight of a polypropylene (PP1) based on the total weight of the polymer composition;
a first polyethylene (A) having a melt flow rate MI2 of at least 2.0 g/10 min as determined according to ISO 1133, condition D, at 190° C. and under a load of 2.16 kg;
a second polyethylene (B) having a melt flow rate MI2 from at least 0.1 g/10 min to below 2.0 g/10 min as determined according to ISO 1133, condition D, at 190° C. and under a load of 2.16 kg; and
optionally an ethylene vinyl acetate copolymer.

In a preferred aspect, the present invention provides a polymer composition comprising:
at least 31.0% by weight of a polypropylene (PP1) based on the total weight of the polymer composition;
a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
a second polyethylene (B) having a melt flow rate MI2 from at least 0.1 g/10 min to below 2.0 g/10 min as determined according to ISO 1133, condition D, at 190° C. and under a load of 2.16 kg; and
optionally an ethylene vinyl acetate copolymer.

In a second aspect, the present invention encompasses an article comprising the polymer composition according to the first aspect of the invention.

In a third aspect, the present invention encompasses a process for making an article according to the second aspect comprising the steps of preparing a polymer composition according to the first aspect of the invention and processing said polymer composition into an article.

The inventors have surprisingly found that compositions comprising a polypropylene, and two different polyethylene polymers with specific melt flow requirements show improved properties. The present inventors have shown that the compositions comprising a polypropylene, such as a heterophasic propylene copolymer, and two different polyethylene polymers with specific melt flow requirements, exhibited improved compatibility between the polypropylene matrix and the dispersed phase, when compared to prior art compositions comprising only polypropylene mixed with high viscosity polyethylene. These prior art polymer compositions had poor dispersions. A poor dispersion is characterized by poor mechanical properties such as low Falling Weight impact; poor haze and other surface defects like breakage. The present compositions exhibited improved mechanical properties.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE FIGURES

FIG. 1 represents a graph plotting Charpy notched impact strength as measured at a temperature of 23° C., as a function of flexural modulus as measured at a temperature of 23° C., for comparative compositions 1-8; and compositions 1-7 according to invention.

### DETAILED DESCRIPTION OF THE INVENTION

When describing the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

Preferred statements (features) and embodiments of the polymer compositions, articles uses and process of this invention are set herein below. Each statements and embodiments of the invention so defined may be combined with any other statement and/or embodiments unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments 1 to 44, with any other aspects and/or embodiments.
1. A polymer composition comprising:
   at least 31.0% by weight of a polypropylene (PP1) based on the total weight of the polymer composition;
   a first polyethylene (A) having a melt flow rate MI2 of at least 2.0 g/10 min as determined according to ISO 1133, condition D, at 190° C. and under a load of 2.16 kg; preferably said first polyethylene (A) is a Ziegler-Natta catalyzed polyethylene;
   a second polyethylene (B) having a melt flow rate MI2 from at least 0.1 g/10 min to below 2.0 g/10 min as determined according to ISO 1133, condition D, at 190° C. and under a load of 2.16 kg; preferably said first polyethylene (B) is a metallocene catalyzed polyethylene; and
   optionally an ethylene vinyl acetate copolymer.
2. A polymer composition comprising:
   at least 31.0% by weight of a polypropylene (PP1) based on the total weight of the polymer composition;
   a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
   a second polyethylene (B) having a melt flow rate MI2 from at least 0.1 g/10 min to below 2.0 g/10 min as determined according to ISO 1133, condition D, at 190° C. and under a load of 2.16 kg; and
   optionally an ethylene vinyl acetate copolymer.
3. The polymer composition according to any one of statements 1 or 2, further optionally comprising a second polypropylene (PP2), preferably wherein said second polypropylene (PP2) is a metallocene catalyzed polypropylene.
4. The polymer composition according to any one of statements 1 to 3, wherein said polypropylene (PP1) is a propylene copolymer.
5. The polymer composition according to any one of statements 1 to 4, wherein said polypropylene (PP1) is a copolymer of propylene with one or more comonomers selected from ethylene and a C4 to C12 olefin, preferably said polypropylene (PP1) is a copolymer of propylene with ethylene as comonomer.
6. The polymer composition according to any one of statements 1 to 5, wherein said polypropylene (PP1) is a heterophasic propylene copolymer, preferably said polypropylene (PP1) is a heterophasic copolymer of propylene with one or more comonomers selected from ethylene and a C4 to C12 olefin, preferably wherein said polypropylene (PP1) is a heterophasic copolymer of propylene with ethylene as comonomer.
7. The polymer composition according to any one of statements 1 to 6, wherein said first polyethylene (A) is a Ziegler Natta-catalyzed polyethylene.
8. The polymer composition according to any one of statements 1 to 7, wherein said second polyethylene (B) is a metallocene-catalyzed polyethylene.
9. The polymer composition according to any one of statements 1 to 8, wherein said first polyethylene (A) has a density of at least 0.945 g/cm³, preferably at least 0.950 g/cm³.
10. The polymer composition according to any one of statements 1 to 9, wherein said first polyethylene (A) has a density ranging from 0.940 to 0.970 g/cm³, preferably from 0.950 to 0.965 g/cm³.
11. The polymer composition according to any one of statement 1 to 10, wherein said second polyethylene (B) has a density of below 0.940 g/cm³ as determined according to ISO 1183-2:2005 at a temperature of 23° C.
12. The polymer composition according to any one of statements 1 to 11, wherein said second polyethylene (B) has a density ranging from 0.910 to below 0.940 g/cm³, preferably from 0.915 to 0.935 g/cm³.
13. The polymer composition according to any one of statements 1 to 12, wherein said polymer composition comprises at least 32.0% by weight of polypropylene (PP1) based on the total weight of the polymer composition.
14. The polymer composition according to any one of statements 1 to 13, wherein said polymer composition comprises at most 90.0% by weight of said polypropylene (PP1), preferably at most 85.0% by weight of said polypropylene (PP1), preferably at most 83.0% by weight, preferably at most 80.0% by weight of polypropylene (PP1) based on the total weight of the polymer composition.
15. The polymer composition according to any one of statements 1 to 14, wherein said polymer composition comprises from 31.0% to 90.0% by weight, preferably from 31.0% to 85.0% by weight, preferably from 31.0% to 83.0% by weight, preferably from 31.0% to 80.0% by weight, for example from 32.0% to 80.0% by weight, for example from 31.0% to 79.0% by weight, preferably from 32.0% to 79.0% by weight of polypropylene (PP1) based on the total weight of the polymer composition.
16. The polymer composition according to any one of statements 1 to 15, wherein said first polyethylene (A) has a melt flow rate MI2 of at least 2.0 g/10 min, preferably at least 3.0 g/10 min, preferably at least 4.0 g/10 min, preferably at least 5.0 g/10 min, preferably at least 6.0 g/10 min, for example from 2.0 g/10 min to 100.0 g/10 min, for example from 2.0 g/10 min to 80.0 g/10 min, for example from 2.0 g/10 min to 50.0 g/10 min, for example from 2.0 g/10 min to 20.0 g/10 min, wherein the melt flow rate is determined according to ISO 1133, condition D, at 190° C. and under a load of 21.6 kg.
17. The polymer composition according to any one of statements 1 to 16, wherein said polymer composition comprises at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition.
18. The polymer composition according to any one of statements 1 to 17, wherein said second polyethylene (B) has a melt flow rate MI2 inferior to 2.0 g/10 min, preferably inferior to 1.99 g/10 min, preferably inferior to 1.95 g/10 min, preferably inferior to 1.90 g/10 min, preferably inferior to 1.8 g/10 min, preferably inferior to 1.6 g/10 min, preferably inferior to 1.5 g/10 min, preferably of from 0.1 g/10 min to 2.0 g/10 min, preferably from 0.1 g/10 min to 1.8 g/10 min, more preferably from 0.1 g/10 min to 1.6 g/10 min, most preferably from 0.1 g/10 min to 1.5 g/10 min, wherein the melt flow rate is determined according to ISO 1133, condition D, at 190° C. and under a load of 21.6 kg.
19. The polymer composition according to any one of statements 1 to 18, wherein said polymer composition comprises at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition.
20. The polymer composition according to any one of statements 1 to 19, wherein said polymer composition further comprises a second polypropylene (PP2), preferably wherein said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min, wherein the melt flow rates are determined according to ISO 1133, condition M at 230° C. and under a load of 2.16 kg; preferably wherein said second polypropylene (PP2) is a metallocene-catalyzed polypropylene.
21. The polymer composition according to any one of statements 1 to 20, wherein said polymer composition comprises
   from 31.0% to 90.0% by weight, preferably from 31.0% to 85.0% by weight, preferably from 31.0% to 83.0% by weight, preferably from 31.0% to 80.0% by weight, for example from 32.0% to 80.0% by weight 31.0% to 79.0% by weight, preferably from 32.0% to 79.0% by weight of polypropylene (PP1) based on the total weight of the polymer composition;
   at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition;
   at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition; and
   from 0.0% to 10.0% by weight of said ethylene vinyl acetate copolymer, preferably from 0.0% to 8.0% by weight, preferably from 0.0% to 6.0% by weight, preferably from 0.0% to 6.5% by weight based on the total weight of the polymer composition.
22. The polymer composition according to any one of statements 1 to 21, wherein said polymer composition comprises
   from 31.0% to 90.0% by weight, preferably from 31.0% to 85.0% by weight, preferably from 31.0% to 83.0% by weight, preferably from 31.0% to 80.0% by weight, for example from 32.0% to 80.0% by weight 31.0% to 79.0% by weight, preferably from 32.0% to 79.0% by weight of polypropylene (PP1) based on the total weight of the polymer composition;
   at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition;
   at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition;
   from 0.0% to 10.0% by weight of said ethylene vinyl acetate copolymer, preferably from 0.5% to 9.0% by weight, preferably from 0.6% to 8.0% by weight, preferably from 0.6% to 7.0% by weight, preferably from 0.7% to 7.5% by weight based on the total weight of the polymer composition; and
   from 0.0 to 30.0% by weight of a second polypropylene (PP2), preferably from 0.0% to 28.0% by weight, preferably from 0.0% to 26.0% by weight, preferably from 0.0% to 24.0% by weight, of the second polypropylene based (PP2) on the total weight of the polymer composition, preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min, wherein the melt flow rates are determined according to ISO 1133, condition M at 230° C. and under a load of 2.16 kg.
23. The polymer composition according to any one of statements 1 to 22, wherein said polymer composition comprises
   from 31.0% to 90.0% by weight, preferably from 31.0% to 85.0% by weight, preferably from 31.0% to 83.0% by weight, preferably from 31.0% to 80.0% by weight, for example from 32.0% to 80.0% by weight 31.0% to 79.0% by weight, preferably from 32.0% to 79.0% by weight of polypropylene (PP1) based on the total weight of the polymer composition;
   at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition;
   at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition;
   from 0.0% to 10.0% by weight of said ethylene vinyl acetate copolymer, preferably from 0.0% to 8.0% by weight, preferably from 0.0% to 6.0% by weight, preferably from 0.0% to 6.5% by weight based on the total weight of the polymer composition; and
   from 0.5 to 30.0% by weight of a second polypropylene (PP2), preferably from 0.7% to 28.0% by weight, preferably from 0.8% to 26.0% by weight, preferably from 1.0% to 24.0% by weight, of the second polypropylene (PP2) based on the total weight of the polymer composition, preferably said second polypropylene (PP2) is selected from the group comprising a propylene homopolymer (PPH) having a melt flow rate of at least 50 g/10 min, and a propylene random copolymer (PPR), preferably a propylene random copolymer having a melt flow rate of at least 0.3 to at most 110 g/10 min, wherein the melt flow rates are determined according to ISO 1133, condition M at 230° C. and under a load of 2.16 kg.
24. The polymer composition according to any one of statements 1 to 23, wherein said polymer composition comprises
   from 31.0% to 90.0% by weight, preferably from 31.0% to 85.0% by weight, preferably from 31.0% to 83.0% by weight, preferably from 31.0% to 80.0% by weight, for example from 32.0% to 80.0% by weight 31.0% to 79.0% by weight, preferably from 32.0% to 79.0% by weight of polypropylene (PP1) based on the total weight of the polymer composition;
   at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition;
   at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition;
   from 0.1% to 10.0% by weight of said ethylene vinyl acetate copolymer, preferably from 0.5% to 9.0% by weight, preferably from 0.6% to 8.0% by weight, preferably from 0.6% to 7.0% by weight, preferably from 0.7% to 7.5% by weight based on the total weight of the polymer composition; and
   from 0.0 to 30.0% by weight of a second polypropylene (PP2), preferably from 0.5% to 28.0% by weight, preferably from 0.8% to 26.0% by weight, preferably from 1.0% to 24.0% by weight, of the second polypropylene (PP2) based on the total weight of the polymer composition, preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min, wherein the melt flow rates are determined according to ISO 1133, condition M at 230° C. and under a load of 2.16 kg.
25. The polymer composition according to any one of statements 1 to 24, wherein said polymer composition comprises a total amount of at most 60.0% by weight of first polyethylene (A) and polyethylene (B), preferably at most 55.0% by weight, preferably at most 50.0% by weight, preferably at most 45.0% by weight based on the total weight of the polymer composition.
26. The polymer composition according to any one of statements 1 to 25, wherein said polymer composition comprises at least 5.0% by weight of first polyethylene (A) and polyethylene (B), preferably at least 10.0% by weight based on the total weight of the polymer composition.
27. The polymer composition according to any of one of statements 1 to 26, wherein said polymer composition comprises said ethylene vinyl acetate copolymer.
28. The polymer composition according to any of one of statements 1 to 27, wherein said polymer composition comprises from 0.5% to 10.0% by weight of said ethylene vinyl acetate copolymer, preferably from 0.5% to 9.0% by weight, preferably from 0.6% to 8.0% by weight, preferably from 0.6% to 7.0% by weight, preferably from 0.7% to 7.5% by weight based on the total weight of the polymer composition.
29. The polymer composition according to any of one of statements 1 to 28, wherein said polymer composition comprises from 0.5% to 30.0% by weight of a second polypropylene (PP2), preferably from 0.7% to 28.0% by weight, preferably from 0.8% to 26.0% by weight, preferably from 1.0% to 24.0% by weight of a second polypropylene (PP2) based on the total weight of the polymer composition, preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min, wherein the melt flow rates are determined according to ISO 1133, condition M at 230° C. and under a load of 2.16 kg.
30. The polymer composition according to any one of statements 1 to 29, wherein said polymer composition comprises a total amount of at least 5.0% by weight of said first polyethylene (A) and second polyethylene (B) based on the total weight of the polymer composition, preferably at least 10.0% by weight of said at first polyethylene (A) and second polyethylene (B) based on the total weight of the polymer composition.
31. The polymer composition according to any one of statements 1 to 30, wherein said second polyethylene (B) is present in an amount of at least 5.0% % by weight, preferably of at least 10.0% by weight, preferably at least 12.0%, preferably at least 16.0% more preferably at least 18.0%, the amount being based on the total amount of said first polyethylene (A) and second polyethylene (B).
32. The polymer composition according to any one of statements 1 to 31, wherein said polymer composition comprises a total amount of at least 45.0% by weight of polypropylene based on the total weight of the polymer composition, preferably at least 50% by weight, preferably at least 55% by weight.
33. The polymer composition according to any one of statements 1 to 32, wherein said ethylene vinyl acetate copolymer has a vinyl acetate content of at least 4.0% by weight based on the total weight of the ethylene vinyl acetate copolymer, as determined by ¹H-NMR analysis.
34. The polymer composition according to any one of statements 1 to 33, wherein said ethylene vinyl acetate copolymer has a melt flow rate MI superior to 0.1 g/10 min as determined according to ISO 1133, condition D, at 190° C. and under a load of 2.16 kg, preferably at least 0.4 g/10 min, preferably at least 0.5 g/10 min, for example at least 0.5 g/10 min to at most 9 g/10 min, for example at least 0.5 g/10 min to at most 4.5 g/10 min.
35. The polymer composition according to any one of statements 1 to 34, wherein said composition further comprises one or more nucleating agents.
36. The polymer composition according to statement 35, wherein said nucleating agent is selected from the group consisting of talc, carboxylate salts, sorbitol acetals, phosphate ester salts, substituted benzene tricarboxamides and polymeric nucleating agents, as well as blends of these.
37. The polymer composition according to any one of statements 1 to 36, wherein said composition further comprises one or more mineral fillers.
38. An article comprising a polymer composition according to any one of statements 1 to 37.
39. The article according to statement 38 wherein said article is an extruded article.
40. The article according to statement 38, wherein said article is an injected article.
41. A process for preparing an article according to any one of statements 38 to 39 comprising the steps of preparing a polymer composition according to any one of statements 1 to 37 and processing said polymer composition into an article.
42. The process according to statement 41 comprising the steps of
   (a) blending, preferably melt blending:
      at least 31.0% by weight of a polypropylene (PP1),
      a first polyethylene (A) having a melt flow rate MI2 of at least 2.0 g/10 min as determined according to ISO 1133, condition D, at 190° C. and under a load of 2.16 kg;
      a second polyethylene (B) having a melt flow rate MI2 inferior to 2.0 g/10 min as determined according to ISO 1133, condition D, at 190° C. and under a load of 2.16 kg;
      optionally an ethylene vinyl acetate copolymer; and
      optionally a second polypropylene (PP2);
   (b) extruding the blend,
   (c) processing the extruded blend in to an article.
43. The process according to statement 41 comprising the steps of
   (a) blending, preferably melt blending:
      at least 31.0% by weight of a polypropylene (PP1),
      a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
      a second polyethylene (B) having a melt flow rate MI2 inferior to 2.0 g/10 min as determined according to ISO 1133, condition D, at 190° C. and under a load of 2.16 kg;
      optionally an ethylene vinyl acetate copolymer; and
      optionally a second polypropylene (PP2);
   (b) extruding the blend,
   (c) processing the extruded blend in to an article.
44. The process according to any one of statements 41 to 43, wherein said processing step comprises using one or more polymer processing techniques selected from injection molding; pipe and fiber extrusion or coextrusion; film and sheet extrusion or co-extrusion, blow molding; rotational molding; foaming; and thermoforming.

According to the present invention, the present polymer composition comprises:

a polypropylene (PP1), wherein said polypropylene (PP1) is present in an amount of at least 31.0% by weight of based on the total weight of the polymer composition;
a first polyethylene (A) having a melt flow rate MI2 of at least 2.0 g/10 min as determined according to ISO 1133, condition D, at 190° C. and under a load of 2.16 kg; preferably said first polyethylene (A) is a Ziegler-Natta catalyzed polyethylene; preferably said polyethylene (A) has a density of at least 0.940 g/cm³ as determined according to ISO 1183-2:2005 at a temperature of 23° C.;
a second polyethylene (B) having a melt flow rate MI2 from at least 0.1 g/10 min to below 2.0 g/10 min as determined according to ISO 1133, condition D, at 190° C. and under a load of 2.16 kg; preferably said first polyethylene (B) is a metallocene catalyzed polyethylene; and
optionally an ethylene vinyl acetate copolymer.

The present polymer composition comprises at least one polypropylene (PP1). For the purposes of the present application, the term “polypropylene” is used to denote propylene homopolymer as well as propylene copolymers. If the polypropylene is a copolymer, the comonomer can be any alpha-olefin i.e. any of ethylene, C4 to C12 alpha-alkylene. The polypropylene (PP1) can be atactic, isotactic or syndiotactic polypropylene. The copolymer can be either a random or heterophasic copolymer.

The term “random” indicates that the comonomers of the propylene copolymer are randomly distributed within the propylene copolymer. The term random is understood according to IUPAC (Glossary of basic terms in polymer science; IUPAC recommendations 1996).

Preferably, the polypropylene (PP1) is a Ziegler Natta catalyzed polypropylene.

In some preferred embodiments, the composition comprises at least 32.0% by weight of a polypropylene (PP1) based on the total weight of the polymer composition; preferably at least 33.0% by weight, preferably at least 34.0% by weight of a polypropylene (PP1) based on the total weight of the polymer composition.

In some preferred embodiments, the polypropylene (PP1) for use in the present polymer composition is a propylene copolymer, more preferably a copolymer of propylene with one or more comonomers selected from ethylene and a C4 to C12 olefin. Preferably said polypropylene (PP1) is a propylene copolymer and is present in the polymer composition in an amount ranging from 31.0% to 90.0% by weight of, preferably from 31.0% to 85.0% by weight based on the total weight of the polymer composition, preferably from 31.0% to 83.0% by weight, preferably from 31.0% to 80.0% by weight, for example from 31.0% to 80.0% by weight, for example from 32.0% to 79.0% by weight.

More preferably, the polypropylene (PP1) is a heterophasic propylene copolymer, preferably a heterophasic copolymer of propylene with one or more comonomers selected from ethylene and a C4 to C12 olefin. Preferred comonomers are ethylene, 1-butene, 1-pentene, 1-hexene, and 1-octene. More preferred comonomers are ethylene and 1-butene. The most preferred comonomer is ethylene.

Generally, a heterophasic polypropylene is a propylene copolymer comprising a propylene homo or random copolymer matrix component (1) and an elastomeric copolymer component (2) of propylene with one or more of ethylene and C4-C12 olefin comonomers, wherein the elastomeric (amorphous) copolymer component (2) is dispersed in said propylene homo or random copolymer matrix polymer (1). Accordingly, the heterophasic copolymer of propylene as used herein means that the elastomeric (amorphous) propylene copolymer component (=elastomeric component) is (finely) dispersed in the polypropylene matrix component.

In some embodiment, the polypropylene (PP1) is a heterophasic propylene copolymer and is present in the polymer composition in an amount from 31.0% to 90.0% by weight, preferably from 31.0% to 85.0% by weight, preferably from 31.0% to 83.0% by weight, preferably from 31.0% to 80.0% by weight, for example from 31.0% to 80.0% by weight, for example from 31.0% to 79.0% by weight, for example from 32.0% to 79.0% by weight of polypropylene based on the total weight of the polymer composition.

In some embodiment, the polypropylene (PP1) for use in the polymer composition can have a melt flow index determined according to ISO 1133, condition M at 230° C. and under a load of 2.16 kg of at least 0.3 g/10 min, preferably of at least 0.5 g/10 min, preferably of at least 1.0 g/10 min, preferably of at least 2.0 g/10 min, preferably of at least 2.5 g/10 min, preferably of at least 3.0 g/10 min, preferably of at least 3.5 g/10 min, preferably of at least 5.0 g/10 min, preferably of at least 10 g/10 min, preferably of at least 15 g/10 min, preferably of at least 20 g/10 min, and preferably of at most 150 g/10 min.

The polymer composition also comprises a first polyethylene (A) having a melt flow rate MI2 as determined according to ISO 1133, condition D, at 190° C. and under a load of 2.16 kg of at least 2.0 g/10 min.

Preferably the polymer composition also comprises a first polyethylene (A) having a melt flow rate MI2 as determined according to ISO 1133, condition D, at 190° C. and under a load of 2.16 kg of at least 2.0 g/10 min and a density of at least 0.940 g/cm³ as determined according to ISO 1183-2:2005 at a temperature of 23° C.

For the purposes of the present application, the term “polyethylene” is used to denote ethylene homopolymer as well as ethylene copolymers. If the polyethylene is a copolymer, the comonomer can be any alpha-olefin i.e. any alpha-alkylene comprising from 3 to 12 carbon atoms, preferably from 3 to 10 carbon atoms, yet more preferably from 3 to 8 carbon atoms, yet more preferably from 3 to 6 carbon atoms, for example, propylene, 1-butene, and 1-hexene. The copolymer can be an alternating, periodic, random, and statistical or heterophasic copolymer.

In some embodiment, the first polyethylene (A) for use in the polymer composition is a Ziegler Natta-catalyzed polyethylene.

Preferably, the first polyethylene (A) for use in the polymer composition has a melt flow rate MI2 of at least 2.0 g/10 min, preferably at least 4.0 g/10 min, preferably at least 5.0 g/10 min, preferably at least 6.0 g/10 min, preferably of from 2.0 g/10 min to 100.0 g/10 min, preferably from 4.0 g/10 min to 80.0 g/10 min, more preferably from 5.0 g/10 min to 50.0 g/10 min, most preferably from 6.0 g/10 min to 20.0 g/10 min.

Preferably, the first polyethylene (A) for use in the polymer composition has a density of at least 0.945 g/cm³ as determined according to ISO 1183-2:2005 at a temperature of 23° C. Preferably, the first polyethylene (A) for use in the polymer composition has a density ranging from 0.945 to 0.970 g/cm³, preferably from 0950 to 0.970 g/cm³, preferably from 0.950 to 0.965 g/cm³, preferably from 0.955 to 0.965 g/cm³.

Preferably said polymer composition comprises at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition.

In some embodiments, said first polyethylene (A) is preferably present in an amount of at least 2.5% by weight; preferably at least 3.0% by weight; preferably at least 4.0%, preferably at least 5.0% by weight based on the total weight of the polymer composition.

The polymer composition also comprises a second polyethylene (B) having a melt flow rate MI2 from at least 0.1 g/10 min to below 2.0 g/10 min.

In an embodiment, the polyethylene (B) for use in the polymer composition is a metallocene-catalyzed polyethylene.

In an embodiment, the polyethylene (B) for use in the polymer composition has a melt flow rate MI2 inferior to 1.99 g/10 min, preferably inferior to 1.95 g/10 min, preferably inferior to 1.90 g/10 min, preferably inferior to 1.85 g/10 min, preferably inferior to 1.80 g/10 min, preferably inferior to 1.60 g/10 min, preferably inferior to 1.50 g/10 min.

In an embodiment, the polyethylene (B) for use in the polymer composition has a melt flow rate MI2 of from 0.10 g/10 min to 1.99 g/10 min, preferably from 0.10 g/10 min to 1.95 g/10 min, preferably from 0.1 g/10 min to 1.90 g/10 min, preferably from 0.1 g/10 min to 1.80 g/10 min, for example from 0.20 g/10 min to 1.95 g/10 min, for example from 0.3 g/10 min to 1.90 g/10 min, for example from 0.4 g/10 min to 1.80 g/10 min, for example from 0.50 g/10 min to 1.85 g/10 min, for example from 0.5 g/10 min to 1.8 g/10 min, for example from 0.5 g/10 min to 1.7 g/10 min, for example from 0.5 g/10 min to 1.6 g/10 min, for example from 0.5 g/10 min to 1.5 g/10 min.

Preferably, the second polyethylene (B) for use in the polymer composition has a density of below 0.940 g/cm³ as determined according to ISO 1183-2:2005 at a temperature of 23° C.

Preferably, the second polyethylene (B) for use in the polymer composition has a density ranging from 0.915 to below 0.940 g/cm³, preferably from 0.910 to 0.935 g/cm³.

Preferably said polymer composition comprises at most 40.0% by weight of said second polyethylene (B), preferably at most 35.0% by weight of said second polyethylene (B), preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition.

In some embodiments, said second polyethylene (B) is preferably present in an amount of at least 2.5% by weight, preferably at least 3.0% by weight, preferably at least 4.0%, preferably at least 5.0% by weight based on the total weight of the polymer composition.

Preferably, the polymer composition comprises a total amount of at most 60.0% by weight of first polyethylene (A) and polyethylene (B), preferably at most 58.0% by weight, preferably at most 54.0% by weight, preferably at most 48.0% by weight based on the total weight of the polymer composition.

Preferably, the polymer composition comprises a total amount of at least 5% by weight of said at first polyethylene (A) and second polyethylene (B) based on the total weight of the polymer composition, preferably at least 8.0% by weight, preferably at least 10.0% by weight of said at first polyethylene (A) and second polyethylene (B) based on the total weight of the polymer composition. More preferably, the polymer composition comprises a total amount of at least 14.0% by weight of said at first polyethylene (A) and second polyethylene (B) based on the total weight of the polymer composition. Even more preferably, the polymer composition comprises a total amount of at least 16.0% by weight of said at first polyethylene (A) and second polyethylene (B) based on the total weight of the polymer composition. Most preferably, the polymer composition comprises a total amount of at least 17.5% by weight of said at first polyethylene (A) and second polyethylene (B) based on the total weight of the polymer composition.

In some embodiment, the polymer composition also comprises at least one ethylene vinyl acetate copolymer (EVA) such as, e.g., polyethylene-co-vinyl acetate.

In some embodiment, said polymer composition comprises from 0.5% to 10.0% by weight of said at least one ethylene vinyl acetate copolymer based on the total weight of the polymer composition. Preferably, the polymer composition comprises from 0.5% to 9.0% by weight of said at least one ethylene vinyl acetate copolymer based on the total weight of the polymer composition, preferably from 0.6% to 8.0% by weight, preferably from 0.6% to 7.5% by weight, preferably from 0.7% to 7.0% by weight, for example from 0.5% to 6.5% by weight, for example from 0.5% to 6.0% by weight based on the total weight of the polymer composition.

In an embodiment, said ethylene vinyl acetate copolymer has a vinyl acetate content of at least 4.0% by weight based on the total weight of the ethylene vinyl acetate copolymer, as determined by ¹H-NMR analysis.

In an embodiment, said ethylene vinyl acetate copolymer has a melt flow rate MI superior to 0.1 g/10 min as determined according to ISO 1133, condition D, at 190° C. and under a load of 2.16 kg, preferably at least 0.4 g/10 min, preferably at least 0.5 g/10 min, for example at least 0.5 g/10 min to at most 9 g/10 min, for example at least 0.5 g/10 min to at most 8 g/10 min, for example at least 0.5 g/10 min to at most 7 g/10 min, for example at least 0.5 g/10 min to at most 6 g/10 min, for example at least 0.5 g/10 min to at most 5 g/10 min, for example at least 0.5 g/10 min to at most 4.5 g/10 min.

Examples of suitable EVA polymers include products under the name EVA 1020 VN5 commercially available from TOTAL Refining and Chemicals, product under the name Elvax™, produced by DuPont, or Evatane™ produced by Arkema. Other suitable EVA polymers are commercially available from Versalis, Exxon, and Repsol.

In some embodiment, the polymer composition also comprises a second polypropylene (PP2). Preferably said second polypropylene (PP2) is a metallocene catalyzed polypropylene. Preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min, wherein the melt flow rates are determined according to ISO 1133, condition M at 230° C. and under a load of 2.16 kg.

Preferably, the second polypropylene (PP2) is a propylene homopolymer (PPH) having a melt flow rate of at least 50 g/10 min, and is a metallocene catalyzed homopolymer. Preferably, the second propylene (PP2) is a random copolymer (PPR), and is a metallocene catalyzed random copolymer, preferably a metallocene-catalyzed propylene random copolymer having a melt flow rate of at least 0.3 to at most 110 g/10 min.

In some embodiment, said polymer composition comprises from 0.0% to 30.0% by weight, preferably 0.5% to 30.0% by weight, preferably from 0.7% to 28.0% by weight, preferably from 0.8% to 26.0% by weight, preferably from 1.0% to 24.0% by weight, the optional second polypropylene (PP2) based on the total weight of the polymer composition.

In some embodiments, said second polypropylene (PP2) is preferably present in an amount of at least 0.1% by weight, for example at least 0.5% by weight, for example at least 1.0% by weight; for example at least 1.2%, for example at least 1.6% for example at least 1.8%, based on the total weight of the polymer composition.

In some embodiment, said polymer composition comprises a total amount of at least 45.0% by weight of said first polypropylene (PP1) and second polypropylene (PP2) based on the total weight of the polymer composition, preferably at least 50.0% by weight, preferably at least 55.0% by weight, preferably at least 58.0% by weight, preferably at least 60.0% by weight based on the total weight of the polymer composition.

In some embodiments, the polymer composition comprises from 31.0% to 90.0% by weight, preferably from 31.0% to 85.0% by weight of said polypropylene (PP1), preferably from 31.0% to 83.0% by weight, preferably from 31.0% to 80.0% by weight, for example from 32.0% to 80.0% by weight, for example from 31.0% to 79.0% by weight, for example from 32.0% to 79.0% by weight of said polypropylene (PP1), based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer; preferably wherein said polypropylene (PP1) is a Ziegler-Natta catalyzed polypropylene;

at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition; preferably wherein said first polyethylene (A) is a Ziegler Natta-catalyzed polyethylene; and preferably wherein said first polyethylene (A) is preferably present in an amount of at least 2.5% by weight; preferably at least 3.0% by weight; preferably at least 4.0%, preferably at least 5.0% by weight based on the total weight of the polymer composition;
at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition; preferably wherein said second polyethylene (B) is a metallocene-catalyzed polyethylene; and preferably wherein said second polyethylene (B) is preferably present in an amount of at least 2.5% by weight, preferably at least 3.0% by weight, preferably at least 4.0%, preferably at least 5.0% by weight based on the total weight of the polymer composition;
from 0.0% to 10.0% by weight of said ethylene vinyl acetate copolymer, preferably from 0.0% to 8.0% by weight, preferably from 0.0% to 6.0% by weight, preferably from 0.0% to 6.5% by weight based on the total weight of the polymer composition.

In some embodiments, the polymer composition comprises

from 31.0% to 90.0% by weight, preferably from 31.0% to 85.0% by weight of said polypropylene (PP1), preferably from 31.0% to 83.0% by weight, preferably from 31.0% to 80.0% by weight, for example from 32.0% to 80.0% by weight, for example from 31.0% to 79.0% by weight, for example from 32.0% to 79.0% by weight of said polypropylene (PP1) based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer;
at least 2.5% by weight of said first polyethylene (A), based on the total weight of the polymer composition, preferably at least 5.0% by weight; preferably wherein said first polyethylene (A) is a Ziegler Natta-catalyzed polyethylene;
at least 2.5% by weight of said second polyethylene (B), based on the total weight of the polymer composition, preferably at least 5.0% by weight; preferably wherein said second polyethylene (B) is a metallocene-catalyzed polyethylene; and
from 0.0% to 10.0% by weight of said ethylene vinyl acetate copolymer, preferably from 0.5% to 9.0% by weight, preferably from 0.6% to 8.0% by weight, preferably from 0.6% to 7.0% by weight, preferably from 0.7% to 7.5% by weight based on the total weight of the polymer composition.

In some embodiments, the polymer composition comprises

from 31.0% to 90.0% by weight of polypropylene (PP1), preferably from 31.0% to 85.0% by weight of said polypropylene (PP1), preferably from 31.0% to 83.0% by weight, preferably from 31.0% to 80.0% by weight, for example from 32.0% to 80.0% by weight, for example from 31.0% to 79.0% by weight, for example from 32.0% to 79.0% by weight of said polypropylene (PP1) based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer;
at least 5.0% by weight of total amount of said first polyethylene (A) and said second polyethylene (B), preferably at least 10.0% by weight, preferably at least 15.0% by weight, preferably at least 20.0% by weight, based on the total weight of the polymer composition; preferably wherein said second polyethylene (B) is a metallocene-catalyzed polyethylene; preferably wherein said second polyethylene (B) is a metallocene-catalyzed polyethylene;
from 0.0% to 10.0% by weight of said ethylene vinyl acetate copolymer, preferably from 0.5% to 9.0% by weight, preferably from 0.6% to 8.0% by weight, preferably from 0.6% to 7.0% by weight, preferably from 0.7% to 7.5% by weight based on the total weight of the polymer composition.

In some embodiments, the polymer composition comprises

from 31.0% to 90.0% by weight of polypropylene (PP1), preferably from 31.0% to 85.0% by weight of said polypropylene (PP1), preferably from 31.0% to 83.0% by weight, preferably from 31.0% to 80.0% by weight, for example from 32.0% to 80.0% by weight, for example from 31.0% to 79.0% by weight, for example from 32.0% to 79.0% by weight of said polypropylene (PP1) based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer; preferably wherein said polypropylene (PP1) is a Ziegler-Natta catalyzed polypropylene;
at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition; preferably wherein said first polyethylene (A) is a Ziegler Natta-catalyzed polyethylene; and preferably wherein said first polyethylene (A) is preferably present in an amount of at least 2.5% by weight; preferably at least 3.0% by weight; preferably at least 4.0%, preferably at least 5.0% by weight based on the total weight of the polymer composition;
at most 40.0% by weight of said second polyethylene (B), preferably at most 35.0% by weight of said second polyethylene (B), preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition; preferably wherein said second polyethylene (B) is a metallocene-catalyzed polyethylene; and preferably wherein said second polyethylene (B) is preferably present in an amount of at least 2.5% by weight, preferably at least 3.0% by weight, preferably at least 4.0%, preferably at least 5.0% by weight based on the total weight of the polymer composition;
from 0.0% to 10.0% by weight of said ethylene vinyl acetate copolymer, preferably from 0.0% to 8.0% by weight, preferably from 0.0% to 6.0% by weight, preferably from 0.0% to 6.5% by weight based on the total weight of the polymer composition; and
from 0.0 to 30.0% by weight of a second polypropylene, preferably from 0.0% to 28.0% by weight, preferably from 0.0% to 26.0% by weight, preferably from 0.0% to 24.0% by weight, of the second polypropylene, preferably wherein said second polypropylene is a metallocene catalyzed polypropylene; preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min.

In some embodiments, the polymer composition comprises

from 31.0% to 90.0% by weight of polypropylene (PP1), preferably from 31.0% to 85.0% by weight of said polypropylene (PP1), preferably from 31.0% to 83.0% by weight, preferably from 31.0% to 80.0% by weight, for example from 32.0% to 80.0% by weight, for example from 31.0% to 79.0% by weight, for example from 32.0% to 79.0% by weight of said polypropylene (PP1) based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer; preferably wherein said polypropylene (PP1) is a Ziegler-Natta catalyzed polypropylene;
at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition; preferably wherein said first polyethylene (A) is a Ziegler Natta-catalyzed polyethylene; and preferably wherein said first polyethylene (A) is preferably present in an amount of at least 2.5% by weight; preferably at least 3.0% by weight; preferably at least 4.0%, preferably at least 5.0% by weight based on the total weight of the polymer composition;
at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition; preferably wherein said second polyethylene (B) is a metallocene-catalyzed polyethylene; and preferably wherein said second polyethylene (B) is preferably present in an amount of at least 2.5% by weight, preferably at least 3.0% by weight, preferably at least 4.0%, preferably at least 5.0% by weight based on the total weight of the polymer composition;
from 0.5% to 10.0% by weight of said ethylene vinyl acetate copolymer, preferably from 0.5% to 9.0% by weight, preferably from 0.6% to 8.0% by weight, preferably from 0.6% to 7.0% by weight, preferably from 0.7% to 7.5% by weight based on the total weight of the polymer composition; and
from 0.0 to 30.0% by weight of a second polypropylene (PP2), preferably from 0.0% to 28.0% by weight, preferably from 0.0% to 26.0% by weight, preferably from 0.0% to 24.0% by weight, of a second polypropylene (PP2) based on the total weight of the polymer composition; preferably wherein said second polypropylene (PP2) is a metallocene catalyzed polypropylene preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min.

In some embodiments, the polymer composition comprises

from 31.0% to 85.0% by weight of said polypropylene (PP1), preferably from 31.0% to 83.0% by weight, preferably from 31.0% to 80.0% by weight, for example from 31.0% to 80.0% by weight, for example from 32.0% to 79.0% by weight, for example from 32.0% to 79.0% by weight of said polypropylene (PP1) based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer; preferably said polypropylene (PP1) is a Ziegler-Natta catalyzed polypropylene;
at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition; preferably wherein said first polyethylene (A) is a Ziegler Natta-catalyzed polyethylene; and preferably wherein said first polyethylene (A) is preferably present in an amount of at least 2.5% by weight; preferably at least 3.0% by weight; preferably at least 4.0%, preferably at least 5.0% by weight based on the total weight of the polymer composition;
at most 40.0% by weight of said second polyethylene (B), preferably at most 35.0% by weight, preferably at most 33.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition; preferably wherein said second polyethylene (B) is a metallocene-catalyzed polyethylene; and preferably wherein said second polyethylene (B) is preferably present in an amount of at least 2.5% by weight, preferably at least 3.0% by weight, preferably at least 4.0%, preferably at least 5.0% by weight based on the total weight of the polymer composition;
from 0.0% to 10.0% by weight of said ethylene vinyl acetate copolymer, preferably from 0.0% to 8.0% by weight, preferably from 0.0% to 6.0% by weight, preferably from 0.0% to 6.5% by weight based on the total weight of the polymer composition; and
from 0.5 to 30.0% by weight of a second polypropylene (PP2), preferably from 0.7% to 28.0% by weight, preferably from 0.8% to 26.0% by weight, preferably from 1.0% to 24.0% by weight, of the second polypropylene (PP2) based on the total weight of the polymer composition; preferably wherein said second polypropylene (PP2) is a metallocene catalyzed polypropylene; preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min.

In some embodiments, the polymer composition comprises

from 31.0% to 90.0% by weight of polypropylene (PP1), preferably from 31.0% to 85.0% by weight of said polypropylene (PP1), preferably from 31.0% to 83.0% by weight, preferably from 31.0% to 80.0% by weight, for example from 32.0% to 80.0% by weight, for example from 31.0% to 79.0% by weight, for example from 32.0% to 79.0% by weight of said polypropylene (PP1) based on the total weight of the polymer composition; preferably wherein said polypropylene (PP1) is a propylene copolymer; preferably wherein said polypropylene (PP1) is a heterophasic propylene copolymer, preferably a heterophasic copolymer of propylene with ethylene as comonomer; preferably said polypropylene (PP1) is a Ziegler-Natta catalyzed polypropylene;
at most 40.0% by weight of said first polyethylene (A), preferably at most 37.0% by weight, preferably at most 35.0% by weight, preferably at most 33.0% by weight, preferably at most 30.0% by weight, for example at most 28.0% by weight, for example at most 27.0% by weight, for example at most 26.0% by weight, for example at most 25.0% by weight, preferably said composition comprises at most 22.0% by weight of said first polyethylene (A) based on the total weight of the polymer composition; preferably wherein said first polyethylene (A) is a Ziegler Natta-catalyzed polyethylene; and preferably wherein said first polyethylene (A) is preferably present in an amount of at least 2.5% by weight; preferably at least 3.0% by weight; preferably at least 4.0%, preferably at least 5.0% by weight based on the total weight of the polymer composition;
at most 40.0% by weight of said second polyethylene (B), preferably at most 38.0% by weight, preferably at most 35.0% by weight, preferably at most 31.0% by weight, preferably at most 30.0% by weight, preferably at most 29.0% by weight, for example at most 28.0% by weight, for example at most 27.0% by weight, for example at most 26.0% by weight, for example at most 25.0% by weight, preferably said composition comprises at most 22.0% by weight of said second polyethylene (B) based on the total weight of the polymer composition; preferably wherein said second polyethylene (B) is a metallocene-catalyzed polyethylene; and preferably wherein said second polyethylene (B) is preferably present in an amount of at least 2.5% by weight, preferably at least 3.0% by weight, preferably at least 4.0%, preferably at least 5.0% by weight based on the total weight of the polymer composition;
from 0.5% to 10.0% by weight of said ethylene vinyl acetate copolymer, preferably from 0.5% to 9.0% by weight, preferably from 0.5% to 8.0% by weight, preferably from 0.5% to 7.0% by weight, preferably from 0.5% to 7.5% by weight based on the total weight of the polymer composition; and
from 0.5 to 30.0% by weight of a second polypropylene (PP2), preferably from 0.7% to 30.0% by weight, preferably from 0.8% to 30.0% by weight, preferably from 1.0% to 30.0% by weight, of the second polypropylene (PP2) based on the total weight of the polymer composition; preferably wherein said second polypropylene (PP2) is a metallocene catalyzed polypropylene; preferably said second polypropylene (PP2) is selected from the group comprising a propylene homopolymer (PPH) having a melt flow rate of at least 50 g/10 min, and a propylene random copolymer (PPR), preferably a propylene random copolymer (PPR) having a melt flow rate of at least 0.3 to at most 110 g/10 min.

The polymer composition may comprise one or more nucleating agents. The nucleating agent used in the present invention can be any of the nucleating agents known to the skilled person. It is, however, preferred that the nucleating agent be selected from the group consisting of talc, carboxylate salts, sorbitol acetals, phosphate ester salts, substituted benzene tricarboxamides and polymeric nucleating agents, as well as blends of these.

The polymer composition may further contain additives, such as, by way of example, processing aids, mould-release agents, primary and secondary antioxidants, acid scavengers, flame retardants, fillers, nanocomposites, lubricants, antistatic additives, nucleating/clarifying agents, antibacterial agents, plasticizers, colorants/pigments/dyes and mixtures thereof. Illustrative pigments or colorants include titanium dioxide, carbon black, cobalt aluminum oxides such as cobalt blue, and chromium oxides such as chromium oxide green. Pigments such as ultramarine blue, phthalocyanine blue and iron oxide red are also suitable. These additives may be included in amounts effective to impart the desired properties.

An overview of the additives that can be used may be found in Plastics Additives Handbook, ed. H. Zweifel, 5th edition, 2001, Hanser Publishers.

The present invention also encompasses an article comprising a polymer composition according to the invention.

The present invention also encompasses a process for preparing an article, comprising the steps preparing a polymer composition according to the invention and processing said polymer composition into an article.

Preferably, the process comprises the steps of
(a) blending, preferably melt blending:
   a polypropylene (PP1); wherein said polypropylene (PP1) is present in an amount of at least 31.0% by weight of a polypropylene (PP1) based on the total weight of the polymer composition;
   a first polyethylene (A) having a melt flow rate MI2 of at least 2.0 g/10 min as determined according to ISO 1133, condition D, at 190° C. and under a load of 2.16 kg;
   a second polyethylene (B) having a melt flow rate MI2 inferior to 2.0 g/10 min as determined according to ISO 1133, condition D, at 190° C. and under a load of 2.16 kg;
   optionally an ethylene vinyl acetate copolymer; and
   optionally a second polypropylene (PP2).
(b) extruding the blend,
(c) processing the extruded blend in to an article.

In some embodiments, the process comprises the steps of
(a) blending, preferably melt blending:
   a polypropylene (PP1); wherein said polypropylene (PP1) is present in an amount of at least 31.0% by weight of a polypropylene (PP1) based on the total weight of the polymer composition;
   a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
   a second polyethylene (B) having a melt flow rate MI2 inferior to 2.0 g/10 min as determined according to ISO 1133, condition D, at 190° C. and under a load of 2.16 kg;
   optionally an ethylene vinyl acetate copolymer; and
   optionally a second polypropylene (PP2).
(b) extruding the blend,
(c) processing the extruded blend in to an article.

Preferably, said processing step comprises using one or more polymer processing techniques selected from injection molding; pipe and fiber extrusion or coextrusion; film and sheet extrusion or co-extrusion, blow molding; rotational molding; foaming; and thermoforming.

The blending of the components of the polymer composition can be carried out according to any physical blending method and combinations thereof known in the art. This can be, for instance, dry blending, wet blending or melt blending. The blending conditions depend upon the blending technique involved.

If dry blending is employed, the dry blending conditions may include temperatures from room temperature up to just under the lowest melting temperature of the polymers employed. The components can be dry blended prior to a melt blending stage, which can take place for example in an extruder. Melt processing is fast and simple and makes use of standard equipment of the thermoplastics industry. The components can be melt blended in a batch process such as in a Brabender Internal Mixer, Banbury, Haake or Clextral extruder or in a continuous process, such as in an extruder e.g. a single or twin screw extruder. During melt blending, the temperature at which the polymers are combined in the blender will generally be in the range between the highest melting point of the polymers employed and up to about 90° C. above such melting point, preferably between such melting point and up to 50° C. above it. The time required for the melt blending can vary broadly and depends on the method of blending employed. The time required is the time sufficient to thoroughly mix the components.

The polymer compositions are useful in applications known to one skilled in the art, such as forming operations (e.g., film, sheet, pipe and fiber extrusion and co-extrusion as well as blow molding, injection molding and rotational molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, pipes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example.

Molded articles include single and multi-layered constructions in the form of bottles, tanks, large hollow articles, rigid food containers, crates and toys; preferred are injection molding of technical parts, compounds for the automotive industry.

The polymer compositions of the present invention may also be used in combination with other polymer compositions; for example in mineral filled polypropylene compounds.

The present invention can allow:
improve the mechanical properties, especially the balance of impact/stiffness
Allowing extreme low volatile of metallocene polypropylene blends
Compatibilizing of recycled polypropylene stream contaminated with polyethylene
Ease of processing of the compositions

The present invention allows increasing the impact properties of compositions comprising impact copolymers (PPC) by blending. The present invention allows increase the melt flow of compositions comprising impact copolymer (PPC) without use of peroxide; and allows getting high impact high melt flow polypropylene blends without the use of peroxide, thereby helping in avoiding all disadvantages linked to the use of peroxide (odor, surface defects in automotive parts). The present invention also allows improving esthetical/optical properties of compositions comprising PPC.

The invention will now be illustrated by the following, non-limiting illustrations of particular embodiments of the invention.

### EXAMPLES

### Density

The density was measured according to the method of standard ISO 1183-2:2005 at a temperature of 23° C.

### The Melt Index

The melt flow rate MI2 of polyethylene was measured according to ISO 1133:1997, condition D, at 190° C. and under a load of 2.16 kg.

The melt flow rate HLMI of polyethylene was measured according to ISO 1133:1997, condition G, at 190° C. and under a load of 21.6 kg.

The melt flow rate of polypropylene was measured according to ISO 1133:1997, condition M, at 230° C. and under a load of 2.16 kg.

The melt flow rate of the composition (blend) was measured according to ISO 1133:1997, condition M, at 230° C. and under a load of 2.16 kg.

### Flexural Modulus

The flexural modulus was determined according to ISO 178:2011 method A with the conditions listed in Table 1.

TABLE 1

| Temperature | 23° C. |
|---|---|
| Test machine | 00-0311 (Zwick tensile testing machine) |
| Force sensor | 200N cell |
| Displacement transducer | Extensometer |
| Norm | ISO-178:2011 method A |
| Test specimen | bar 80 mm × 10 mm × 4 mm cut from |
| | type 1A specimen |
| Pre-charge | 0.5N |
| Test speed | 2 mm/min |
| Span between specimen supports | 64 mm |
| End of the test | 1.5% |
| Relative humidity | 50% ± 10% |

### Tensile Properties

Tensile properties were measured according to ISO 527-2:2012 with the conditions listed in Table 2.

TABLE 2

| Temperature | 23° C. |
|---|---|
| Test machine | 00-0311 (Zwick tensile testing machine) |
| Force sensor | 10 kN |
| Displacement transducer | Extensometer |
| Norm | ISO-527:2012 |
| Test specimen | bar 80 mm × 10 mm × 4 mm cut from |
| | type 1A specimen |
| Pre-charge | 5N |
| Modulus speed | 1 mm/min |
| Test speed | 50 mm/min |
| Thickness average | 4.07 mm |
| Average width | 10.05 mm |
| Relative humidity | 50% ± 10% |

### Notched Impact for the Results Given in Table 7

Notched Charpy was performed according to ISO 179-1, sample type 1A, with the conditions listed in Table 3.

TABLE 3

| | |
|---|---|
| Temperature | 23° C. |
| Norm | ISO 179-1:2001 |
| Notch type | Type 1A |
| Test specimen | bar 80 mm × 10 mm × 4 mm cut |
| | from type 1A specimen |

### Notched Izod for the Results Given in Table 8

Notched Izod was performed according to ISO 180:2001, V notch sample type 1A, with the conditions listed in Table 4. Izod impact is defined as the kinetic energy needed to initiate a fracture in a polymer sample specimen and continue the fracture until the specimen is broken. Tests of the Izod impact strength determine the resistance of a polymer sample to breakage by flexural shock as indicated by the energy expended from a pendulum type hammer in breaking a standard specimen in a single blow. The specimen is notched which serves to concentrate the stress and promote a brittle rather than ductile fracture. Specifically, the Izod impact test measures the amount of energy lost by the pendulum during the breakage of the test specimen. The energy lost by the pendulum is the sum of the energies required to initiate sample fracture, to propagate the fracture across the specimen, and any other energy loss associated with the measurement system (e.g., friction in the pendulum bearing, pendulum arm vibration, sample toss energy, etc.).

TABLE 4

| | |
|---|---|
| Temperature | 23° C. |
| Norm | ISO 180:2001 |
| Impact energy | 1.00 J |
| Notch type | V-Notch Type 1A |
| Test specimen | bar 80 mm × 10 mm × 4 mm cut |
| | from type 1A specimen |

### Falling Weight Impact Test

The falling weight test on 60×60×2 mm plaques was performed according to ISO 6603-2:2002 with the following conditions: The tests were done on a Fractovis Ceast equipment with a hammer M2091 having a diameter of 12.7 mm and a weight of 19.927 kg. The hammer was not lubricated. The test speed was 4.43 m/s. the number of points was 15000. The frequency was 1333 kHz. An internal digital trigger was used. Test specimens were in the form injection-molded plates and had the following dimensions 60×60×2 mm. The diameter of the sample holder was 40 mm. The tests were carried out at a temperature of −20° C. The height was 1.0 m and the impact energy was 195.44 J. The results are based upon an average of 5 samples.

Ductility index (DI) (%)=((Energy at break−Energy at Peak)/Energy at break)×100

Default classification: (≤10: Fragile, >10 and ≤35: intermediate, >35: Ductile)

### Injection Molding Conditions

The test specimens for Flexural Modulus, Izod, Notched Impact, Tensile properties determinations were prepared by injection molding.

Test specimens used in the tests disclosed in Table 8 (Flexural, Izod, Tensile), standard ISO 294-1:1998
Cycle time=60 s
Injection: pressure=1200 bar, time=1.9 s
Holding: pressure=280 bar, time=40 s
Temperature profile=180° C. to 200° C.
Mold temperature=30° C.
Cooling time=14.5 s

Test specimens used in the tests disclosed in Table 7: norm ISO 294-1
Cycle time=50 s
Injection: pressure=1200 to 2400 bar
Holding: pressure=700 bar, time=3 s
Temperature profile=150° C. to 170° C.
Mold temperature=40° C.
Cooling time=35 s

### VA Content in EVA

The ¹H-NMR analysis was performed using a 500 MHz Bruker NMR spectrometer with a high temperature 5 mm probe under conditions such that the signal intensity in the spectrum is directly proportional to the total number of contributing hydrogen atoms in the sample. Such conditions are well known to the skilled person and include for example sufficient relaxation time etc. In practice, the intensity of a signal is obtained from its integral, i.e. the corresponding area. The data were acquired using 32 scans per spectrum, a pulse repetition delay of 10 seconds and a spectral width of 15 ppm at a temperature of 130° C. The sample was prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as internal standard. To give an example, about 60 mg of polymer were dissolved in 0.5 ml of TCB, followed by addition of 0.25 ml of C₆D₆ and 1 drop of HMDS.

Following data acquisition, the chemical shifts are referenced to the signal of the internal standard HMDS, which is assigned a value of δ 0.055 ppm. The VA content was determined by ¹H-NMR analysis on the total polymer. The different chemical shifts can be found below in Table 5 and were assigned using published data.

TABLE 5

| | Chemical shifts |
|---|---|
| Sort of Hydrogen | (ppm) |
| 1H mono | 7.2 |
| CHO VA + 1H mono | 5.2-4.56 |
| 1H mono | 4.5 |
| CH₃ VA | 2.1-1.9 |
| 4 E + 5 VA + 3H mono | 2.6-0.5 |

The following normalized areas are defined to estimate the VA content:

Mono area=(H mono 7.2 ppm+H mono 4.5 ppm)/2

VA area=(CHO VA+1H mono area)−mono area

E area=((4E+5VA+3H mono) area−5 VA area−3 mono area)/4

The VA content is then calculated according to the following equation:

VA content (% weight)=VA area*8600/(mono area*86+VA area*86+E area*28)

### Example 1

In this example, the following components were used:

Polypropylene PPC 9760 is a commercial Ziegler-Natta heterophasic copolymer with a melt flow rate of 25 g/10 min as determined according to ISO 1133 (230° C., 2.16 kg) and a density of 0.905 g/cm³ (ISO 1183) commercially available from TOTAL Refining and Chemicals.

Polypropylene PPC 9712 is a commercial heterophasic copolymer with a melt flow rate of 25 g/10 min as determined according to ISO 1133 (230° C., 2.16 kg) and a density of 0.905 g/cm³ (ISO 1183) commercially available from TOTAL Refining and Chemicals.

Polypropylene PPC 9612 is a commercial heterophasic copolymer with a melt flow rate of 20 g/10 min as determined according to ISO 1133 (230° C., 2.16 kg) and a density of 0.905 g/cm³ (ISO 1183) commercially available from TOTAL Refining and Chemicals.

Polypropylene Lumicene® MH140CNO is a commercial metallocene homopolymer polypropylene with a melt flow rate of 140 g/10 min as determined according to ISO 1133 (230° C., 2.16 kg) and a density of 0.905 g/cm³ (ISO 1183) commercially available from TOTAL Refining and Chemicals.

Polypropylene Aceso® Lumicene® MR10MM0 is a commercial metallocene random copolymer polypropylene with a melt flow rate of 10 g/10 min as determined according to ISO 1133 (230° C., 2.16 kg)) and a density of 0.902 g/cm³ (ISO 1183) commercially available from TOTAL Refining and Chemicals.

Polyethylene HD6081 is a commercial high density Ziegler-Natta polyethylene having a melt flow rate of 8 g/10 min as determined according to ISO 1133 (190° C., 2.16 kg) and a density of 0.960 g/cm³ (ISO 1183), commercially available from TOTAL Refining and Chemicals.

Lumicene® Supertough 32ST05 is a commercial metallocene polyethylene having a melt flow rate MI2 of 0.5 g/10 min as determined according to ISO 1133 (190° C., 2.16 kg), and a density of 0.931 g/cm³ (ISO 1183), commercially available from TOTAL Refining and Chemicals.

Polyethylene Lumicene® mPE MI810EP is a commercial metallocene linear low density polyethylene with 1-hexene as comonomer having a melt flow rate of 1.0 g/10 min as determined according to ISO 1133 (190° C., 2.16 kg), and a density of 0.917 g/cm³ (ISO 1183), commercially available from TOTAL Refining and Chemicals.

mPE is a metallocene polyethylene having a melt flow rate of 16 g/10 min as determined according to ISO 1133 (190° C., 2.16 kg), and a density of 0.935 g/cm³ (ISO 1183).

EVA 1020 VN 5 is a commercial ethylene vinyl acetate copolymer with a melt flow rate of 2 g/10 min as determined according to ISO 1133 (190° C., 2.16 kg), with a VA content of 17.5%, a melting temperature of 87° C. (ISO 11357-3:2013) and a density of 0.940 g/cm³ (ISO 1183) commercially available from TOTAL Refining and Chemicals.

Polyethylene HDPE 56020 S XP is a commercial very high molecular weight high density polyethylene having a high melt flow rate HLMI of 1.4 g/10 min as determined according to ISO 1133 (190° C., 21.6 kg), a MI2 of 0.02 g/10 min as determined according to ISO 1133 (190° C., 2.16 kg) and a density of 0.952 g/cm³ (ISO 1183), commercially available from TOTAL Refining and Chemicals.

Different compositions were prepared. The components of the compositions are shown in Table 6. Unless otherwise stated the amounts are given in weight % (wt. %), based on the total weight of the composition.

TABLE 6

| | PPC | | | HDPE 56020 | Polyethylene | EVA | Superthough | | Lumicene |
|---|---|---|---|---|---|---|---|---|---|
| | 9760 | MH140CN0 | MR10MM0 | XP | HD 6081 | 1020VN5 | 32ST05 | mPE | M1810 |
| Composition 1 according | 35.0 | | 20.0 | | 20.0 | 5.0 | | | 20.0 |
| to the invention | | | | | | | | | |
| Composition 2 according | 72.5 | | | | 6.5 | 1.0 | | | 20.0 |
| to the invention | | | | | | | | | |
| Composition 3 according | 60.0 | | | | 20.0 | | 20.0 | | |
| to the invention | | | | | | | | | |
| Composition 4 according | 65.5 | | 1.5 | | 17.5 | | | | 15.5 |
| to the invention | | | | | | | | | |
| Composition 5 according | 59.0 | 10.0 | | | 12.5 | 3.0 | 15.5 | | |
| to the invention | | | | | | | | | |
| Composition 6 according | 77.0 | | | | 14.0 | 4.0 | 5.0 | | |
| to the invention | | | | | | | | | |
| Composition 7 according | 55.7 | 19.3 | | | 20.0 | | | | 5.0 |
| to the invention | | | | | | | | | |
| Comparative composition 1 | 55.0 | | | | 20.0 | 5.0 | | 20.0 | |
| Comparative composition 2 | 55.0 | | 20.0 | | 5.0 | | | 20.0 | |
| Comparative composition 3 | 40.0 | 20.0 | | | 20.0 | | | 20.0 | |
| Comparative composition 4 | 55.0 | 20.0 | | 5.0 | | | | | 20.0 |
| Comparative composition 5 | 55.0 | | 20.0 | 20.0 | | | | 5.0 | |
| Comparative composition 6 | 70.0 | | 20.0 | 5.0 | | | 5.0 | | |
| Comparative composition 7 | 75.0 | | | 20.0 | | | | | 5.0 |
| Comparative composition 8 | 70.0 | 20.0 | | 5.0 | | | | 5.0 | |

Compositions 1, 2, 3, 4, 5, 6 and 7 according to the invention and comparative compositions 1, 2, 3, 4, 5, 6, 7 and 8 were extruded on Brabender 20/40 extruder, using the following conditions:
Twin screw co-rotating, 20 mm screw diameter, L/D=40
Screw speed=200 rpm
Temperature profile=180/190/190/190/190/190° C.

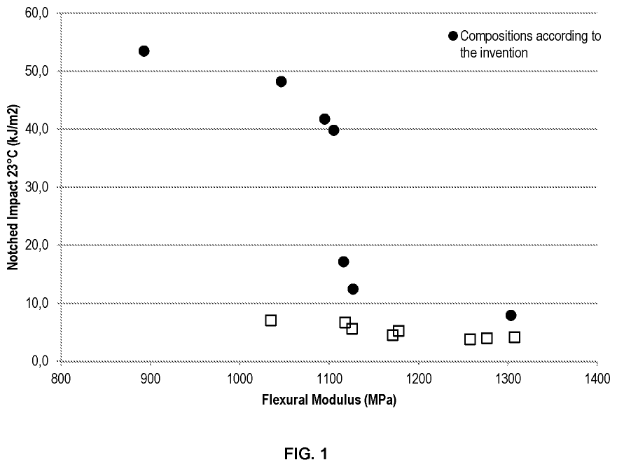

The properties of the samples prepared with the compositions were measured. The results are shown in Table 7 and FIG. 1.

TABLE 7

| | | | | Charpy |
|---|---|---|---|---|
| | | | | notched |
| | Flexural | Yield | Elongation | impact |
| | Modulus | Strength | at break | strength |
| | [MPa] | [MPa] | [%] | [KJ/m] |
| Composition 1 according | 893 | 21.5 | 698.8 | 53.5 |
| to the invention | | | | |
| Composition 2 according | 1046 | 22.1 | 101.2 | 48.2 |
| to the invention | | | | |
| Composition 3 according | 1095 | 23.7 | 47.8 | 41.7 |
| to the invention | | | | |
| Composition 4 according | 1105 | 23.3 | 60.7 | 39.8 |
| to the invention | | | | |
| Composition 5 according | 1116 | 23.5 | 45.6 | 17.2 |
| to the invention | | | | |
| Composition 6 according | 1127 | 23.2 | 35.8 | 12.4 |
| to the invention | | | | |
| Composition 7 according | 1303 | 25.9 | 21.2 | 7.9 |
| to the invention | | | | |
| Comparative composition 1 | 1034 | 22.3 | 214.9 | 7.1 |
| Comparative composition 2 | 1125 | 24.9 | 667.1 | 5.6 |
| Comparative composition 3 | 1258 | 26.3 | 32.9 | 3.8 |
| Comparative composition 4 | 1117 | 23.3 | 12.6 | 6.7 |
| Comparative composition 5 | 1171 | 26.2 | 12.3 | 4.5 |
| Comparative composition 6 | 1177 | 25.5 | 17.5 | 5.3 |
| Comparative composition 7 | 1276 | 23.7 | 6.6 | 4.0 |
| Comparative composition 8 | 1307 | 25.3 | 8.6 | 4.2 |

The compositions according to the invention exhibit good compatibility and good mechanical properties.

Compositions 2 4 and 7 according to the invention were compared in Table 8 with different commercial heterophasic polypropylenes. As can be seen, the compositions according to the invention display good properties while being non nucleated and non-rheology controlled compositions. This is an advantage in terms of processing but can also been seen as a potential to further improve the stiffness of the blend by adding a nucleating additive. The data for composition according to the invention, wherein nucleation has taken effect, shows a slightly improved impact resistance.

TABLE 8

| | | | | | | Falling | |
|---|---|---|---|---|---|---|---|
| | | | | | | Weight - | |
| | | | | Flexural | Notched | 20° C. | |
| | | Controlled | | Modulus | Izod 23° C. | Emax | Etot |
| | Nucleated | rheology | MFI | [Mpa} | [kJ/m²] | [J] | [J] |
| PPC9712 | Yes | Yes | 25 | 1050 | 42 | 12 | 22 |
| PPC9612 | Yes | Yes | 20 | 1150 | 20 | 13 | 23 |
| PPC9760 | No | No | 25 | 1250 | 7 | 4.8 | 4.9 |
| Composition 2 according to | No | No | 15 | 1039 | 19 | 15 | 24 |
| the invention | | | | | | | |
| Composition 4 according to | No | No | 13 | 1076 | 20 | 12 | 20 |
| the invention | | | | | | | |
| Composition 7 according to | No | No | 29 | 1257 | 5.7 | 13 | 18 |
| the invention | | | | | | | |
| Composition 2 according to | +nucleation | No | 15 | 1189 | 19 | 15 | 24 |
| the invention | | | | | | | |
| Composition 4 according to | +nucleation | No | 13 | 1226 | 20 | 12 | 20 |
| the invention | | | | | | | |

1.-15. (canceled)

16. A polymer composition comprising:
at least 31.0% by weight of a polypropylene (PP1) based on the total weight of the polymer composition;
a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
a second polyethylene (B) having a melt flow rate MI2 from at least 0.1 g/10 min to below 2.0 g/10 min as determined according to ISO 1133, condition D, at 190° C. and under a load of 2.16 kg; and
optionally an ethylene vinyl acetate copolymer.

17. The polymer composition according to claim 16, wherein said first polyethylene (A) is a Ziegler Natta-catalyzed polyethylene.

18. The polymer composition according to claim 16, wherein said second polyethylene (B) is a metallocene-catalyzed polyethylene.

19. The polymer composition according to claim 16, wherein said first polyethylene (A) has a density ranging from 0.940 to 0.970 g/cm³.

20. The polymer composition according to claim 16, wherein said second polyethylene (B) has a density of below 0.940 g/cm³ as determined according to ISO 1183-2:2005 at a temperature of 23° C.

21. The polymer composition according to claim 16, wherein said polypropylene (PP1) is a propylene copolymer.

22. The polymer composition according to claim 16, wherein said polypropylene (PP1) is a copolymer of propylene with one or more comonomers selected from ethylene and a C4 to C12 olefin.

23. The polymer composition according to claim 16, wherein said polypropylene (PP1) is a heterophasic propylene copolymer.

24. The polymer composition according to claim 16, wherein said polymer composition comprises at most 40.0% by weight of said first polyethylene (A) based on the total weight of the polymer composition.

25. The polymer composition according to claim 16, wherein said polymer composition comprises at most 40.0% by weight of said first polyethylene (B) based on the total weight of the polymer composition.

26. The polymer composition according to claim 16, wherein said polymer composition comprises from 0.5% to 10.0% by weight of said optional ethylene vinyl acetate copolymer based on the total weight of the polymer composition.

27. The polymer composition according to claim 16, wherein said polymer composition comprises a total amount of at least 5.0% by weight of said at first polyethylene (A) and second polyethylene (B) based on the total weight of the polymer composition.

28. An article comprising a polymer composition according to claim 16.

29. The article according to claim 28, wherein said article is an injected or extruded article.

30. A process for making an article according to according to claim 28 comprising the steps of preparing a polymer composition comprising:
at least 31.0% by weight of a polypropylene (PP1) based on the total weight of the polymer composition;
a first polyethylene (A) having a melt flow rate MI2 of at least 2.0 g/10 min as determined according to ISO 1133, condition D, at 190° C. and under a load of 2.16 kg and a density of at least 0.940 g/cm³ as determined according to ISO 1183-2:2005 at a temperature of 23° C.;
a second polyethylene (B) having a melt flow rate MI2 from at least 0.1 g/10 min to below 2.0 g/10 min as determined according to ISO 1133, condition D, at 190° C. and under a load of 2.16 kg; and
optionally an ethylene vinyl acetate copolymer;
and processing said polymer composition into an article.
